(19) United States
(12) Patent Application Publication
(10) Pub. No.: US 2010/0008060 A1
(43) Pub. Date: Jan. 14, 2010

(54) LIGHT ASSEMBLY WITH HIGH COLOR-RENDERING PROPERTY

(75) Inventor: Wei-Ping SHAO, Keelung City (TW)

Correspondence Address: Dugan & Dugan, PC, 245 Saw Mill River Road, Suite 309, Hawthorne, NY, 10532, US

(73) Assignee: CANDLE LABORATORY CO., LTD, Gueishan Township (TW)

(21) Appl. No.: 12/491,207

(22) Filed: Jun. 24, 2009

(30) Foreign Application Priority Data
Jul. 10, 2008 (TW) 97212242

(51) Int. Cl. F21V 9/14; F21V 9/00; H01J 1/62

(52) U.S. Cl. 362/19; 362/293; 313/483; 313/495

(57) ABSTRACT

A light assembly is provided. The light assembly includes at least one ultraviolet (UV) lamp and a wavelength-converting member. The wavelength-converting member encircles the UV lamp and includes a substrate, and a wavelength-converting layer disposed on the substrate and faces the UV lamp. In this way, the wavelength-converting layer is energized by the ultraviolet light emitted from the UV lamp to emit a visible light in turn.

### RELATED APPLICATIONS

This application claims priority to Taiwan Application Serial Number 97212242, filed Jul. 10, 2008, which is herein incorporated by reference.

### BACKGROUND

1. Field of Invention

The present invention relates to a light assembly with high color-rendering property. More particularly, the present invention relates to a light assembly with high color-rendering property and a long service life.

2. Description of Related Art

The fluorescent lamp is a common illuminating device. Generally, the fluorescent lamp includes a fluorescent tube made of glass, and two sockets disposed at two ends of the fluorescent tube for connecting to the power supply and holding the fluorescent tube in position. The fluorescent tube is filled with inert gases (such as argon or a mixture of argon and neon) and mercury vapor. A fluorescent coating is formed on the inner surface of the fluorescent tube. Tungsten-based filaments are disposed at two end of the fluorescent tube. When electric currents flow through the filaments, the filaments would glow and emit electrons. These electrons collide with and ionize the inert gas atoms in the tube surrounding the filaments to form a plasma whereby the mercury vapor is excited to emit ultraviolet light having wavelengths of about 253.7 nm and about 185 nm. The fluorescent coating is in turn energized by said ultraviolet light to emit a visible light.

Color rendering is the effect of a light source on the color appearance of objects by conscious or subconscious comparison with their color appearance under a reference light source. Quantitatively, the color-rendering property of a light source is expressed as the color rendering index (CRI). The CRI is calculated by comparing the color rendering of a test light source to that of a reference light source which is usually selected from illuminant series D of CIE (International Commission on Illumination) standard illuminants. By definition, the reference light source has a CRI of 100 (Ra=100). The best possible faithfulness to a reference is specified by a CRI of 100, while the very poorest is specified by a CRI of zero.

In an environment illuminated by high color-rendering light sources, the color appearance perceived by human beings is more natural, and hence, the demand for light assemblies with high color-rendering property is increasing. Commercially available light assemblies such as T5 fluorescent lamps and cold cathode fluorescent lamps (CCFLs) have operating lives of more than 20,000 hours, but their CRI values are usually less than 90. With respect to light assemblies having s CRI values of about 90-95, an average service life thereof is in the range of 6,000 to 10,000 hours which is less than half of that of the T5 fluorescent lamps.

In view of the foregoing, there is a need in the related art to provide light assemblies with high color-rendering property and a long service life.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present invention is directed to a light assembly with high color-rendering property and a long service life that is used in a lighting apparatus or a backlight module.

According to one embodiment of the present invention, the light assembly comprises at least one ultraviolet (UV) lamp and a wavelength-converting member. The wavelength-converting member encircles the UV lamp and comprises a substrate and a wavelength-converting layer disposed on the substrate and faces the UV lamp. In this way, the wavelength-converting layer is energized by the UV light emitted from the UV lamp to emit a visible light in turn.

In another aspect, the present invention is directed to a light assembly with high color-rendering property and a long service life that is used in a lighting apparatus or a backlight module.

According to one embodiment of the present invention, the light assembly comprises at least one UV lamp, a hollow tube, and a phosphor layer disposed on the inner surface of the hollow tube. The hollow tube encircles the UV lamp with the phosphor layer disposed thereon facing the UV lam, and thereby the phosphor layer is energized by the UV light to emit a visible light.

According to some embodiments of the present invention, the hollow tube has a cross-section that is circular, elliptic, or polygonal in shape.

According to one embodiment of the present invention, the hollow tube is made of glass. According to another embodiment of the present invention, the hollow tube is made of a thermoplastic material.

Many of the attendant features will be more readily appreciated as the same becomes better understood by reference to the following detailed description considered in connection with the accompanying drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram showing a conventional fluorescent light assembly;

FIG. 2 is a schematic diagram illustrating a light assembly with high color-rendering property according to one embodiment of the present invention; and

FIG. 3 is a schematic diagram illustrating a light assembly with high color-rendering property according to another embodiment of the present invention.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

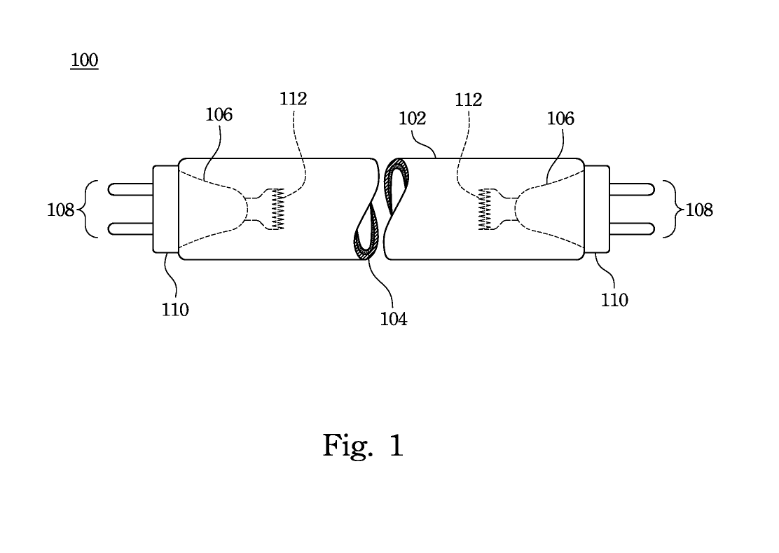

FIG. 1 is a schematic diagram illustrating a conventional fluorescent light assembly 100. In FIG. 1, the conventional fluorescent light assembly 100 comprises a tube 102, a phosphor layer 104, a pair of electrodes 106, multiple pins 108, a pair of caps 110, and a pair of filaments 112. The phosphor layer 104 is formed on an inner surface of the tube 102. The tube 102 is filled with inert gases (such as argon or a mixture of argon and neon) and mercury vapor. The electrodes 106 are respectively disposed on two ends of the tube 102 and electrically connected to pins 108 on the caps 110. The filaments 112 are electrically connected to the electrodes 106. The caps 110 serve to seal the tube 102 and hold the electrodes 106 in position.

In operation, electric currents would flow through the filaments 112 whereby the filaments 112 emit electrons. These electrons collide with and ionize the inert gas atoms in the tube 102 surrounding the filaments 112 to form a plasma whereby the mercury vapor is excited to emit UV light. The phosphor layer 104 is in turn energized by said UV light to emit a visible light.

As is well known to those with ordinary skill in the art, the phosphor powders in the phosphor layer are critical to the illuminating quality of the fluorescent light assembly. For example, degradations such as lattice defects occurring in the phosphor powders would result in the alternation of color or luminance of light emitted by the fluorescent light assembly. Common lattice defects can be categorized into the alternation of the crystal structure and the formation of the color centers, both of which are briefly described in the following paragraphs.

When the plasma is formed, the mercury ions would compound with neighboring electrons and generate an energy of about 10.42 eV during the compounding process. Said energy would cause damage to the crystal structure of the phosphor powders of the phosphor layer 104 whereby resulting in lattice defects therein and thus decreasing the luminance of the light emitted by the phosphor powders.

Moreover, under high operating temperature, the phosphor powders of the phosphor layer 104 absorb the UV light (especially the UV light having a wavelength of 185 nm) whereby resulting in color centers therein. The emission spectrum and/or absorption spectrum of the crystal lattice having color centers are different from those of the normal crystal lattice. Hence, the wavelength and the color of the light emitted by the phosphor powders having color centers are different from those of the undamaged phosphor powders. In a conventional fluorescent light assembly 100, the formation of color centers also lowers the luminance of the light emitted by the phosphor powders.

More particularly, with respect to conventional light tubes having high color-rendering property (i.e., the color rendering index of which is higher than 90%), the phosphor powders are rich in phosphorous, which makes the phosphor powders more unstable. Hence, the problem of phosphor powder degradation is more severe.

As stated above, one factor affecting the service life of a fluorescent light assembly is the quality of the phosphor powders. Further, in conventional fluorescent light assembly 100, phosphor powders with high color-rendering property tend to degrade faster than normal phosphor powders do, and therefore, the service life of the light assembly with high color-rendering property is less than half of that of the ordinary T5 light tube.

In view of the foregoing, a light assembly having high color-rendering property and long service life that is substantially equal to or longer than the service life of T5 fluorescent lamps is provided in one aspect of the present invention. The light assembly is suitable to be used in a lighting apparatus or a backlight module.

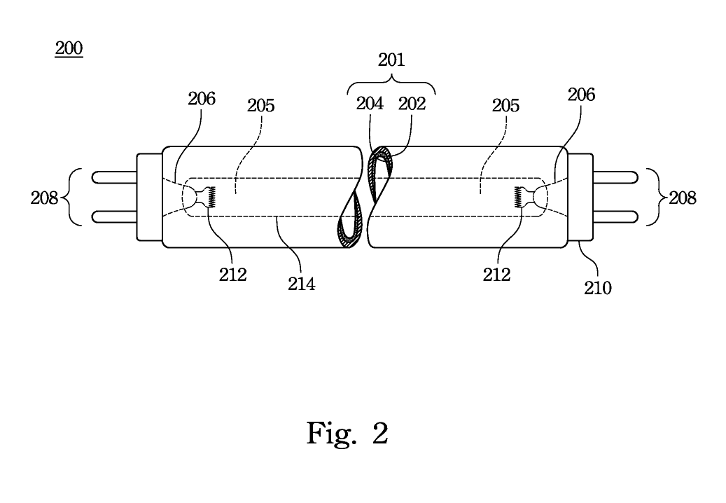

FIG. 2 is a schematic diagram illustrating a light assembly 200 with high color-rendering property according to one embodiment of the present invention. In FIG. 2, the light assembly 200 comprises at least one ultraviolet lamp 205 for emitting an ultraviolet light and a wavelength-converting member 201 encircling the ultraviolet lamp 205. Specifically, the wavelength-converting member 201 comprises a substrate 202, and a wavelength-converting layer 204 disposed on the substrate 202 and faces the ultraviolet lamp 205. The wavelength-converting layer 204 is energized by the ultraviolet light emitted by the ultraviolet lamp 205 to emit a visible light.

According to embodiments of the present invention, the UV lamp 205 is similar to conventional UV lamps in structure and material. Generally, the tube of the UV lamp 205 is made of glass.

Continuing with FIG. 2, the light assembly 200 also comprises some other elements including but are not limited to at least one pair of electrodes 206, at least a pair of filaments 212, and a pair of sealing members 210. The electrodes 206 are respectively disposed on two ends of the UV lamp 205 and electrically connected to pins 208 on the sealing members 210. The filaments 212 are electrically connected to the electrodes 206, respectively. Each of the sealing members 210 is a metal cap or a sealant that serves to seal the light assembly 200 and hold the UV lamp 205 in position.

According to various embodiments of this invention, the substrate 202 can have a rigid structure or a flexible structure. For example, the substrate 202 can be made of glass and thus has a rigid structure. Alternatively, the substrate 202 can be made of thermoplastic material and thus has a flexible structure. In some embodiments, the thermoplastic material is poly(methyl methacrylate) (PMMA), polystyrene (PS), methyl methacrylate-co-styrene (MS), polycarbonate, (PC), polyethylene terephthalate (PET), or polyimide. In the embodiment shown in FIG. 2, the substrate 202 is made of glass.

Moreover, the substrate 202 may further comprise an additional layer disposed thereon, such as a diffusion layer, a brightness enhancement layer, or a reflective polarizer brightness enhancement layer. Suitable selection of the additional layer depends on the material of the substrate 202.

In this embodiment, the substrate 202 is a hollow tube. As shown in FIG. 2, the substrate 202 has a cross-section that is circular in shape; however, the invention is not limited thereto, and the cross-sectional shape of the substrate 202 can be decided depending on manufacturing design or the application of the light assembly. For example, the substrate 202 may have a cross-section that is elliptic or polygonal (i.e., triangular, quadrangular, pentagonal, or polygons having more line segments) in shape.

According to various embodiments of the present invention, the wavelength-converting layer 204 may be any layer that is suitable to convert the UV light emitted by the UV lamp 205 into a light having desired wavelength. For example, the wavelength-converting layer 204 is a light sensitive layer, a phosphor layer, a photoluminescent layer, a quantum dot layer, a quantum line layer, or a quantum well layer.

In the embodiments where the wavelength-converting layer 204 is a phosphor layer, the wavelength-converting layer 204 may comprise any suitable phosphor powders, more particularly, the phosphor powders having high color-rendering property. For example, the phosphor powders having high color-rendering property can be hydrolyzed colloid reaction (HCR) phosphor powders. Main composition of the HCR phosphor powders comprises red phosphor powders having a formula of Y(P,V)O₄:Eu, green phosphor powders having a formula of BaMgAl₁₀O₁₇:Eu,Mn or Zn₂SiO₄:Mn, and blue phosphor powders having a formula of Sr₅(PO₄)₃Cl:Eu.

It should be noted that although only one UV lamp 205 is shown in FIG. 2, the light assembly according to the embodiments of the present invention may comprise any numbers of UV lamp 205. For example, the light assembly may use two, three, four, five or more UV lamps.

In operation, electric currents would flow through the filaments 212 whereby the filaments 212 emit electrons. These electrons collide with and ionize the inert gas atoms (not shown in the figure) in the UV lamp 205 surrounding the filaments 212 to form a plasma whereby the mercury vapor is excited to emit UV light. The main mercury emission wavelength is in the UVC range (about 100 to 280 nm). Commercially-available UV lamps using low pressure mercury-vapor emit most of their light at about 254 nm and 185 nm.

According to the embodiments of the present invention, the 185 nm-UV light and 254 nm-UV light would pass through the glass tube 214 of the UV lamp 205. The glass of the UV lamp 205 would filter out most of the 185 nm-UV light; thus, only a nominal amount of the 185 nm-UV light would reach the wavelength-converting layer 204 disposed on the inner surface of the substrate 202. In the mean time, the 254 nm-UV light mostly stays unaffected by the glass of the UV lamp 205 and reaches the wavelength-converting layer 204. Consequently, the phosphor powders (not shown in the figure) of the wavelength-converting layer 204 are energized by the arrived UV lights and subsequently emit visible light. In this way, the amount of the 254 nm-UV light contacting the wavelength-converting layer 204 is minimized; thus reducing the possibility of the color center formation.

In addition, by disposing the wavelength-converting layer 204 on the inner surface of the substrate 202 would substantially reduce degradation of phosphor powder caused by being in contact with the mercury vapor, for the wavelength-converting layer 204 is no longer exposed in the mercury vapor contained within the glass tube 214 of the UV lamp 205.

Therefore, in the light assembly according to embodiments of the present invention, the degradation rate of the phosphor powders, especially the phosphor powders with high color-rendering property, would be substantially decreased. As such, as compared with conventional light assemblies with high color rendering index, the service life of the light assembly according to embodiments of the present invention is extended so that it is substantially equal to or longer than the service life of T5 fluorescent lamps.

Optionally, the interior space of the wavelength-converting member 201 is substantially evacuated such that the light assembly 200 is more suitable to be used in environments having low working temperatures, such as at about 0° C. As will occur to those with ordinary skill in the art, the luminance of light emitted by the conventional fluorescent light assembly would be decreased as the working temperature is lowered. The luminance of a fluorescent light assembly at temperature below 0° C. is less than half of the luminance of the same fluorescent light assembly at about 30° C. Therefore, by substantially evacuating the interior space defined by the wavelength-converting member 201 within the light assembly 200, the heat (or the temperature) of the ambient environment is less likely to be transferred to the interior of the light assembly 200. In this way, as comparing with the light assembly not being evacuated, the luminance variation of the light assembly of this embodiment under different ambient temperatures is relatively small. As such, the light assembly according to this embodiment is suitable to be used in an environment with low working temperature.

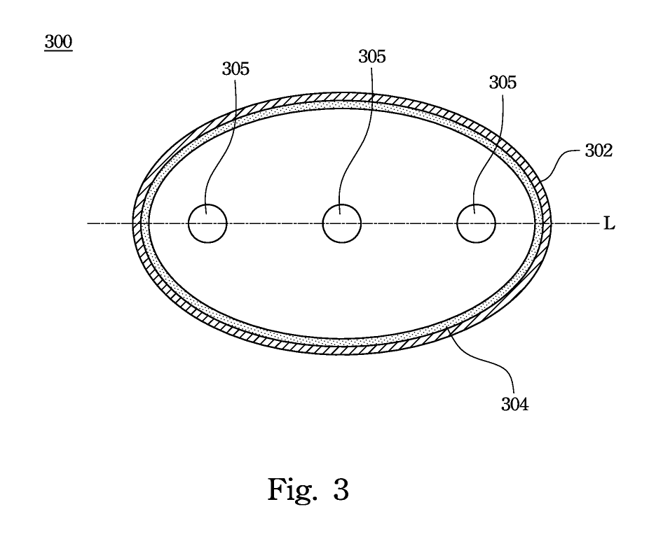

FIG. 3 is a schematic diagram illustrating a light assembly 300 with high color-rendering property according to another embodiment of the present invention. The light assembly 300 has a long service life that is substantially equal to or longer than the service life of T5 fluorescent lamps. The light assembly 300 can be used in a lighting device and more particularly in a backlight module.

The light assembly 300 comprises three UV lamps 305 for emitting UV light, a hollow tube 302 encircling the UV lamps 305, and a phosphor layer 304 disposed on the inner surface of the substrate, and the phosphor layer 304 is energized by the ultraviolet light to emit a visible light.

Each of the UV lamps 305 is similar to the UV lamp 205 of FIG. 2. For example, each of the UV lamps 305 may have a pair of electrodes (not shown in FIG. 3) respectively disposed at two ends of the UV lamp, and a pair of filaments (not shown in FIG. 3) that are electrically connected to the electrodes.

Also, the light assembly 300 may comprise a pair of sealing members (not shown in FIG. 3) disposed on two ends of the hollow tube 304 to seal the light assembly 300 and hold the UV lamps 305 in position. Similarly, the sealing member is a metal cap or a sealant.

According to the principle and spirit of the present invention, some parts of the UV light emitted by the UV lamps 305 would pass through the glass tube walls of the UV lamps 305 to reach the phosphor layer 304 while the other part is absorbed (filtered) by the glass tube walls of the UV lamps 305.

In this embodiment, the hollow tube 302 has a cross-section that is elliptic in shape; however, the hollow tube of other embodiments can have other cross-sectional shape as described with respect to FIG. 2.

It should be noted that although three UV lamps 305 are shown in FIG. 3, the light assembly 300 may use any suitable number of UV lamps. For example, the light assembly 300 may use two, three, four, five or more UV lamps. Also, in FIG. 3, the UV lamps 305 are disposed on the long axis L of the elliptic hollow tube 302; while in other embodiments the arrangement of UV lamps can be adjusted depending on the design or application needs.

According to embodiments of the present invention, the material of the hollow tube 302 is a thermoplastic material such as those described with respected to FIG. 2. More particularly, the hollow tube 302 is made of a sheet PET. Then, the phosphor powders are directly coated over one surface of the PET sheet to form a phosphor layer 304 thereon. Thereafter, the PET sheet is rolled into a hollow tube 302 with the phosphor layer 304 disposed on the inner surface thereof.

As will occur to those skilled in the art, other features and/or advantages described with respect to the embodiments of FIG. 2 can be incorporated to or combined with the embodiments of FIG. 3. Specifically, the interior space defined by hollow tube 302 can be substantially evacuated, so that the light assembly 300 is suitable to be used in environments having low working temperatures.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A light assembly, comprising:
at least one ultraviolet lamp for emitting an ultraviolet light; and
a wavelength-converting member encircling the ultraviolet lamp, wherein the wavelength-converting member comprises:
a substrate; and
a wavelength-converting layer disposed on the substrate and facing the ultraviolet lamp, wherein the wavelength-converting layer emits a visible light upon being energized by the ultraviolet light.

2. The light assembly according to claim 1, wherein the wavelength-converting member defines an interior space in the light assembly, and the interior space is substantially evacuated.

3. The light assembly according to claim 1, wherein the wavelength-converting member further comprises a layer disposed on the substrate, wherein the layer is a diffusion layer, a brightness enhancement layer, or a reflective polarizer brightness enhancement layer.

4. The light assembly according to claim 1, wherein the substrate is made of glass.

5. The light assembly according to claim 1, wherein the substrate is made of a thermoplastic material.

6. The light assembly according to claim 5, wherein the thermoplastic material is poly(methyl methacrylate), polystyrene, methyl methacrylate-co-styrene, polycarbonate, polyethylene terephthalate, or polyimide.

7. The light assembly according to claim 1, wherein the wavelength-converting layer is a light sensitive layer, a phosphor layer, a photoluminescent layer, a quantum dot layer, a quantum line layer, or a quantum well layer.

8. A light assembly with high color-rendering property, further comprising two sealing members respectively disposed at two ends of the light assembly.

9. The light assembly according to claim 8, wherein each of the sealing members is a metal cap or a sealant.

10. The light assembly according to claim 1, wherein the wavelength-converting member has a cross-section that is circular, elliptic, or polygonal in shape.

11. A light assembly, comprising:
at least one ultraviolet lamp for emitting an ultraviolet light;
a hollow tube encircling the ultraviolet lamp; and
a phosphor layer disposed on the inner surface of the hollow tube, and the phosphor layer emits a visible light upon being energized by the ultraviolet light.

12. The light assembly according to claim 11, wherein the hollow tube defines an interior space in the light assembly, and the interior space is substantially evacuated.

13. The light assembly according to claim 11, further comprising two sealing members respectively disposed at two ends of the hollow tube.

14. The light assembly according to claim 13, wherein each of the sealing members is a metal cap or a sealant.

15. The light assembly according to claim 13, wherein the hollow tube has a cross-section that is circular, elliptic, or polygonal in shape.

16. The light assembly according to claim 11, wherein the hollow tube is made of a thermoplastic material.

17. The light assembly according to claim 16, wherein the thermoplastic material is poly(methyl methacrylate), polystyrene, methyl methacrylate-co-styrene, polycarbonate, polyethylene terephthalate, or polyimide.
